(19) United States
(12) Patent Application Publication
(10) Pub. No.: US 2012/0003503 A1
(43) Pub. Date: Jan. 5, 2012

(54) MAGNETIC RECORDING MEDIUM AND METHOD OF MANUFACTURING THE SAME

(75) Inventor: Masahiko MORI, Minami-ashigara-shi (JP)

(73) Assignee: FUJIFILM CORPORATION, Tokyo (JP)

(21) Appl. No.: 13/175,121

(22) Filed: Jul. 1, 2011

(30) Foreign Application Priority Data
Jul. 2, 2010 (JP) 2010-152075

(51) Int. Cl. G11B 5/712; G11B 5/842

(52) U.S. Cl. 428/843.1; 427/128

(57) ABSTRACT

An aspect of the present invention relates to a method of manufacturing a magnetic recording medium comprising dispersing magnetic particles in a water-based solvent having a pH that is lower than an isoelectric point of the magnetic particles to prepare a magnetic liquid, wherein the dispersing is conducted to a state of dispersion where a particle diameter in liquid is equal to or lower than 35 nm; adjusting a zeta potential of the magnetic particles to within a range of 0 to 25 mV by modifying a surface of the magnetic particles with the addition of a prescribed surface-modifying agent to the. magnetic liquid; dispersing the magnetic particles after the adjusting together with an organic solvent and a binder to prepare a magnetic coating material; and forming a magnetic layer of the magnetic recording medium with the magnetic coating material that has been prepared.

### CROSS-REFERENCE TO RELATED APPLICATIONS

This application claims the benefit of priority under 35 USC 119 to Japanese Patent Application No. 2010-152075 filed on Jul. 2, 2010, which is expressly incorporated herein by reference in its entirety.

### BACKGROUND OF THE INVENTION

1. Field of the Invention

The present invention relates to a magnetic recording medium and to a method of manufacturing the same. More particularly, the present invention relates to a magnetic recording medium having a magnetic layer in which magnetic particles are highly dispersed, and to a method of manufacturing the same.

2. Discussion of the Background

In recent years, the means of rapidly transmitting information have undergone considerable development, permitting the transmission of data and images containing immense amounts of information. With this improvement in data transmission technology has come the demand for higher density recording in recording media and recording and reproduction devices for recording, reproducing, and storing information. The high dispersion of microparticulate magnetic powder and increased smoothing of the surface of the magnetic layer to reduce spacing loss are known to be effective ways of achieving good electromagnetic characteristics in the high-density recording region.

As means of increasing the dispersion of magnetic particles, Document 1 (Japanese Unexamined Patent Publication (KOKAI) Showa No. 61-54034, which is expressly incorporated herein by reference in its entirety) proposes dispersing magnetic particles, the surfaces of which have been coated with a water-soluble polymer surfactant, in an organic solvent containing sodium dioctyl sulfosuccinate and a binder component, to prepare a magnetic coating material for forming a magnetic layer. Document 2 (Journal of the Ceramic Society of Japan, 97 [1] (1989) pp. 73-78, which is expressly incorporated herein by reference in its entirety) proposes dispersing magnetic particles in an aqueous solution of high-molecular-weight sodium polyacrylate, followed by solvent replacement to prepare an organic solvent-based magnetic coating material.

In Documents 1 and 2, based on the knowledge that it is advantageous in terms of enhancing dispersion to conduct the dispersion in an aqueous system because the surfaces of the magnetic particles are hydrophilic, an organic solvent-based magnetic coating material is prepared after coating the surfaces of the magnetic particles with the water-soluble polymer in the aqueous solution.

However, even when dispersion down to the primary particles is achieved in an aqueous solution, when magnetic particles the surfaces of which have been coated with a water-soluble polymer as described in Document 1 are dried, van der Waals' forces and magnetic forces end up forming solid aggregates. It is extremely difficult to redisperse particles that have been aggregated by drying into primary particles.

By contrast, Document 2 proposes not conducting a drying step after coating the magnetic particle surfaces with a water-soluble polymer in a water-based solvent and replacing the water-based solvent with an organic solvent to increase dispersion. However, the magnetic particles that have been coated with a water-soluble polymer end up forming aggregates due to the interaction between hydrophilic moieties in the organic solvent following solvent replacement, making it difficult to achieve the high degree of dispersion demanded of a high-density magnetic recording medium.

### SUMMARY OF THE INVENTION

Accordingly, an aspect of the present invention provides for a magnetic recording medium having a magnetic layer in which magnetic particles are highly dispersed.

The present inventor conducted extensive research into achieving the above magnetic recording medium, resulting in the following discoveries.

In a water-based solvent with a pH lower than the isoelectric point of the magnetic particles, the surfaces of the magnetic particles become positively charged. The repulsive forces between positive charges permit a high degree of dispersion without adding a water-soluble polymer as described in Documents 1 and 2. If a compound having both a hydrophobic moiety with high affinity for organic solvent and an anionic group is present in this state, the anionic group adsorbs to the positively charged sites on the surface of the highly dispersed magnetic particle, coating the surface of the magnetic particle with the hydrophobic moiety and rendering it hydrophobic. At the same time, the positive charge of the surface of the magnetic particle is canceled out, reducing the repulsive force between positive charges. This reduction of the repulsive force between positive charges and rendering the surfaces hydrophobic causes the magnetic particles in the water-based solvent to aggregate. Since the aggregates that form are the result of the interaction between hydrophobic moieties, the state of aggregation can be readily eliminated in an organic solvent (in a hydrophobic environment) because the hydrophobic moieties exhibit affinity for the organic solvent.

That is, the present inventors discovered that it was possible to disperse the magnetic particles to a high degree in an organic solvent by modifying the surface of magnetic particles with a compound (surface-modifying agent) having both an anionic group and a hydrophobic moiety with high affinity for the organic solvent in a state where the magnetic particles were highly dispersed in a water-based solvent by repulsive forces between positive charges.

The present inventor conducted further research based on this discovery, and devised the present invention.

An aspect of the present invention relates to a method of manufacturing a magnetic recording medium comprising:

dispersing magnetic particles in a water-based solvent having a pH that is lower than an isoelectric point of the magnetic particles to prepare a magnetic liquid, wherein the dispersing is conducted to a state of dispersion where a particle diameter in liquid is equal to or lower than 35 nm;

adjusting a zeta potential of the magnetic particles to within a range of 0 to 25 mV by modifying a surface of the magnetic particles with the addition of a surface-modifying agent to the magnetic liquid, the surface-modifying agent being selected from the group consisting of compounds denoted by general formula (I) and compounds denoted by general formula (II);

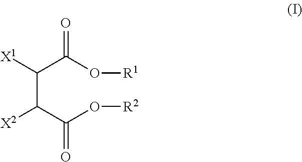

wherein, in general formula (I), each of R¹ and R² independently denotes an alkyl group with 5 to 10 carbon atoms; and X¹ and X² denote hydrogen atoms or substituents, with either X¹ or X² denoting a functional group that becomes an anionic group in the magnetic liquid;

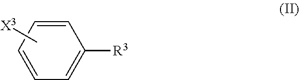

wherein, in general formula (II), R³ denotes an alkyl group with 12 to 17 carbon atoms, and X³ denotes a functional group that becomes an anionic group in the magnetic liquid;

dispersing the magnetic particles after the adjusting together with an organic solvent and a binder to prepare a magnetic coating material; and

forming a magnetic layer of the magnetic recording medium with the magnetic coating material that has been prepared.

The functional group that becomes an anionic group in the magnetic liquid may be a sulfonic acid group or a sulfonate group.

The above method may further comprise, after the surface modification in the magnetic liquid, collecting the magnetic particles from the water-based solvent.

The magnetic particles may be hexagonal ferrite magnetic particles.

The above method may further comprise adjusting the pH of the water-based solvent, the pH being equal to or lower than 5.

In general formula (II), the functional group denoted by X³ may be present on a para position with respect to the alkyl group denoted by R³.

In an embodiment, in general formula (I), either X¹ or X² denotes the functional group that becomes an anionic group in the magnetic liquid, and the other denotes a hydrogen atom.

The content of the surface-modifying agent in the magnetic liquid may range from 5 to 15 weight parts per 100 weight parts of the magnetic particles.

The organic solvent may comprise a ketone solvent.

In the adjusting, the zeta potential of the magnetic particles may be adjusted to within a range of 0 to 10 mV.

A further aspect of the present invention relates to a magnetic recording medium manufactured by the above manufacturing method.

The present invention can provide a magnetic recording medium in which microparticulate magnetic material is highly dispersed, affording good electromagnetic characteristics.

Since dispersion of the microparticulate magnetic material can be readily achieved, the load of dispersing the magnetic particles in the manufacturing process can be greatly reduced.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The method of manufacturing a magnetic recording medium of the present invention comprises:

dispersing magnetic particles in a water-based solvent having a pH that is lower than an isoelectric point of the magnetic particles to prepare a magnetic liquid, wherein the dispersing is conducted to a state of dispersion where a particle diameter in liquid is equal to or lower than 35 nm;

adjusting a zeta potential of the magnetic particles to within a range of 0 to 25 mV by modifying a surface of the magnetic particles with the addition of a surface-modifying agent to the magnetic liquid, the surface-modifying agent being selected from the group consisting of compounds denoted by general formula (I) and compounds denoted by general formula (II);

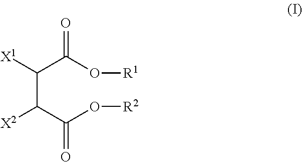

wherein, in general formula (I), each of R¹ and R² independently denotes an alkyl group with 5 to 10 carbon atoms; and X¹ and X² denote hydrogen atoms or substituents, with either X¹ or X² denoting a functional group that becomes an anionic group in the magnetic liquid;

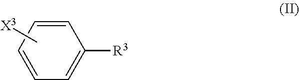

wherein, in general formula (II), R³ denotes an alkyl group with 12 to 17 carbon atoms, and X³ denotes a functional group that becomes an anionic group in the magnetic liquid;

dispersing the magnetic particles after the adjusting together with an organic solvent and a binder to prepare a magnetic coating material; and

forming a magnetic layer of the magnetic recording medium with the magnetic coating material that has been prepared.

The method of manufacturing a magnetic recording medium of the present invention will be described in greater detail below.

### Dispersion Processing in a Water-Based Solvent

The presence of magnetic particles in the form of microparticles in the magnetic layer of a magnetic recording medium enhances the electromagnetic characteristics thereof. Accordingly, it is desirable for microparticulate magnetic particles to be present in the magnetic layer in a highly dispersed state to enhance electromagnetic characteristics.

In this regard, the starting material magnetic particles employed to manufacture the magnetic recording medium of the present invention desirably have an average primary particle size of equal to or lower than 35 nm. In this context, the average primary particle size of the magnetic particles is a value measured by the following method.

The magnetic particles are photographed at 100,000-fold magnification with a model H-9000 transmission electron microscope made by Hitachi and printed on photographic paper at an overall magnification of 500,000-fold to obtain a particle photograph. The targeted magnetic particles are selected in the particle photograph, the contours of the particles are traced with a digitizer, and the particle size is measured with KS-400 Carl Zeiss image analysis software. The size of 500 primary particles is measured. The term “primary particle” refers to an independent particle that has not aggregated. The arithmetic average of the particle size as measured by this method is adopted as the average primary particle size of the magnetic particles.

From the perspective of obtaining stable magnetization without heat fluctuation, the average primary particle size is desirably equal to or greater than 10 nm. From the perspective of achieving both stable magnetization and high-density recording, the average particle size desirably falls within a range of 10 to 35 nm, preferably within a range of 20 to 35 nm. However, even when the starting material magnetic particles are microparticles, if they are present as aggregates in the magnetic layer, the aggregates will behave like coarse particles, making it difficult to enhance electromagnetic characteristics. Accordingly, in the present invention, as set forth further below, dispersion processing and surface modification processing are conducted in a water-based solvent to form a magnetic layer in which magnetic particles are highly dispersed. This processing is described further below.

In the present invention, the size of the particles or powder of magnetic particles or the like (referred to as the “particle size” hereinafter), (1) is given by the length of the major axis of the particle, that is, the major axis length when the particles are acicular, spindle-shaped, cylindrical in shape (with the height being greater than the maximum major diameter of the bottom surface), or the like; (2) is given by the maximum major diameter of the plate surface or bottom surface when the particles are tabular or cylindrical in shape (with the thickness or height being smaller than the maximum major diameter of the plate surface or bottom surface); and (3) is given by the diameter of a circle of equal perimeter when the particles are spherical, polyhedral, or of indeterminate shape, and the major axis of the particle cannot be specified based on the shape. The term “diameter of a circle of equal perimeter” can be obtained by circular projection.

The average particle size of the particles is the arithmetic average of the above particle size and is obtained by measuring 500 primary particles, as set forth above.

Various magnetic particles such as the hexagonal ferrite magnetic particles and ferromagnetic metal magnetic particles that are commonly employed in the magnetic layer of a magnetic recording medium can be employed as starting material magnetic particles to manufacture the magnetic recording medium in the present invention. Details are provided further below.

In the manufacturing method of the present invention, before surface-modifying the magnetic particles with a surface-modifying agent, described further below, the magnetic particles are subjected to dispersion processing in a water-based solvent. The pH of the water-based solvent in which the dispersion processing is conducted is lower than the isoelectric point of the magnetic particles. That is done, as set forth above, to highly disperse the magnetic particles in a water-based solvent with a pH of lower than the isoelectric point of the magnetic particles by means of the repulsive force between positive charges, and to impart a positive charge to the surfaces of the magnetic particles so that they become adsorption sites for the anionic groups of the surface-modifying agent.

In the present invention, the term “isoelectric point of the magnetic particles” means the pH value when the zeta potential of the magnetic particles goes to zero. Specifically, the magnetic particles are added to the water-based solvent being employed to a concentration of 0.02 weight percent. A pH adjusting agent (such as a 30 weight percent acetic acid aqueous solution) is then added while monitoring the zeta potential with a zeta potential measuring device (such as a Zetasizer Nano Series made by Sysmex). When the zeta potential goes to zero, the pH is measured. That pH value is adopted as the isoelectric point of the magnetic particles. In the present invention, the terms “isoelectric point,” “zeta potential,” and “pH” refer to the values measured at a solution temperature of 25° C.

The term “water-based solvent” means a solvent that is comprised mainly of water. Examples are: water and mixed solvents of water and water-soluble organic solvents, such as methanol, ethanol, acetone, N,N-dimethylformamide, N,N-dimethylacetamide, and tetrahydrofuran.

Many of the magnetic particles that are generally employed in the magnetic layers of magnetic recording media are surface processed with alumina or the like, which has an isoelectric point in the basic range (for example, see Japanese Examined Patent Publication (KOKOKU) Showa No. 62-50889, which is expressly incorporated herein by reference in its entirety), and thus have isoelectric points that are in the basic range. For magnetic particles with isoelectric points in the basic range, it is possible to keep the pH value of the water-based solvent lower than the isoelectric point of the magnetic particles by employing an organic or inorganic acid as a pH adjusting agent. Adjustment to a pH that is three or more points lower than the dielectric point of the magnetic particles is desirable to achieve good dispersion of the magnetic particles by means of the repulsive force of positive charges. Taking into account the dielectric point of common magnetic particles, a pH of equal to or lower than 5 is desirable and equal to or lower than 4 is preferred. Under strongly acidic conditions, there are cases in which the surface of the magnetic particles will dissolve. Thus, a pH of equal to or higher than 3 is desirable.

Examples of inorganic acids that can be employed as pH adjusting agents are: hydrochloric acid, sulfuric acid, nitric acid, boric acid, and phosphoric acid. Examples of organic acids are amino acids, acetic acid, glycolic acid, and diglycolic acid. Of these, acetic acid is desirably employed from the perspective of ease of handling, and hydrochloric acid, which is a strong acid, is desirably employed from the perspective of permitting pH adjustment by the addition of just small quantities.

A magnetic liquid (dispersion liquid) in which magnetic particles are highly dispersed by means of the repulsive forces between positive charges can be obtained by the above dispersion processing. When surface modification of the magnetic particles is conducted by adding a surface-modifying agent to the magnetic liquid, the repulsive forces between positive charges diminish, and the magnetic particles temporarily aggregate. However, this state of aggregation can be readily eliminated in an organic solvent-based magnetic coating material. Accordingly, the dispersion state of the magnetic particles in the magnetic coating material, and the dispersion state of the magnetic particles in the magnetic layer, can end up being equivalent to the dispersion state in the magnetic liquid. Thus, it is necessary for the magnetic particles to be present in the magnetic liquid in a highly dispersed state. The particle diameter in liquid is employed as an indicator of this dispersion state in the present invention. The term “particle diameter in liquid” is the maximum major diameter corresponding to 50 percent in the cumulative distribution curve of the particle size distribution. The particle size distribution is measured by the dynamic light-scattering method. For example, this can be done by taking 50 repeat measurements with an LB-500 dynamic light-scattering particle size distribution measuring device made by Horiba, Ltd. To increase the measurement precision, the liquid being measured can be diluted prior to measuring the particle diameter in liquid. In that case, to further enhance the measurement precision, it is desirable to employ the solvent contained in the liquid being measured as the diluting solvent, and preferable to employ the same solvent as the liquid being measured. When the magnetic liquid is being diluted, the dilution is desirably made with a water-based solvent adjusted to the same pH as the magnetic liquid.

When the particle diameter in liquid exceeds 35 nm in the magnetic liquid, it is difficult to form a magnetic layer in which magnetic particles are present in a microparticulate state capable of permitting high-density recording. Accordingly, in the present invention, the magnetic particles are dispersion processed to a dispersion state such that the particle diameter in liquid is equal to or lower than 35 nm in the water-based solvent having a pH lower than the isoelectric point of the magnetic particles. From the perspective of achieving stable magnetization without heat fluctuation, the particle diameter in liquid is desirably equal to or higher than 10 nm. From the perspective of achieving both stable magnetization and high-density recording, the particle diameter in liquid desirably falls within a range of 10 to 35 nm, preferably a range of 20 to 35 nm. The particle diameter in liquid of the magnetic liquid can be controlled by means of the pH of the water-based solvent and the size of the starting material magnetic particles.

Next, a prescribed surface-modifying agent is added to the magnetic liquid and the surface of the magnetic particles is modified to adjust the zeta potential of the magnetic particles to within a range of 0 to 25 mV. Adding the surface-modifying agent to the magnetic liquid in which the magnetic particles are present in a highly dispersed state makes it possible to coat the surface-modifying agent on the surface of the magnetic particles that are present in a highly dispersed state (desirably a state close to that of primary particles). The zeta potential of the magnetic particles following processing (surface-modification) with the surface-modifying agent is an indicator of the rate of coverage by the surface-modifying agent. The effect of modification by the surface-modifying agent is inadequate and dispersion of the magnetic particles in the organic solvent cannot be adequately ensured when the zeta potential exceeds 25 mV after surface modification in magnetic particles with a particle diameter in liquid of equal to or lower than 35 nm. By contrast, a state in which the zeta potential is equal to or lower than 25 mV is one in which the surface of the magnetic particles is coated with the surface-modifying agent to the extent that the magnetic particles will disperse well in the organic solvent. From the perspective of achieving a good coating effect with the surface-modifying agent, the zeta potential is desirably equal to or lower than 20 mV, preferably equal to or lower than 18 mV, and still more preferably, equal to or lower than 10 mV. A state in which the zeta potential of the magnetic particles is 0 mV, that is, a state in which the anionic groups of the surface-modifying agent have adsorbed to all of the positive charges on the surface of the magnetic particles and the positive charges on the surface of the magnetic particles have all been neutralized. A state in which the zeta potential is negative is a state in which the surface-modifying agent covers the surface of the magnetic particles in two layers. In such a state, the surface of the magnetic particles that have been coated with the surface-modifying agent becomes a hydrophilic surface and dispersion decreases in the organic solvent, making it difficult to obtain a magnetic coating material in which the magnetic particles are highly dispersed. Accordingly, in the present invention, the zeta potential is set to equal to or higher than 0 mV. Further, the zeta potential of the magnetic particles after the surface modification processing is the zeta potential of a portion of the solution that is collected and diluted with water so that the concentration of magnetic particles is 0.02 weight percent. The zeta potential measuring device that is employed can be, for example, a Zetasizer Nano Series made by Sysmex.

The surface-modifying agent employed in the present invention to modify the surface of the magnetic particles in the magnetic liquid is selected from the group consisting of compounds denoted by general formula (I) below and compounds denoted by general formula (II) below. The compounds denoted by general formula (I) below and compounds denoted by general formula (II) below will be sequentially described.

In the present invention, unless specifically stated otherwise, the groups that are given can be substituted or unsubstituted. When a given group has a substituent, the substituent can be, for example, an alkyl group (such as an alkyl group having 1 to 6 carbon atoms), a hydroxyl group, an alkoxyl group (such as an alkoxyl group having 1 to 6 carbon atoms), a halogen atom (such as a fluorine, chlorine, or bromine atom), a cyano group, an amino group, a nitro group, an acyl group, or a carboxyl group. For a group having a substituent, the number of carbon atoms given means the number of carbon atoms of the portion not including the substituent. In the present invention, a range expressed with the word “to” indicates a range that includes the preceding and succeeding values as the minimum and maximum, respectively.

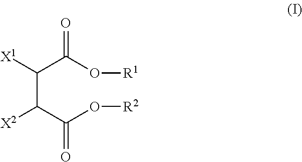

In general formula (I), each of R¹ and R² independently denotes an alkyl group with 5 to 10 carbon atoms. The alkyl group may be linear or branched, but is desirably a branched alkyl group from the perspective of effectively rendering the surface of the magnetic particles hydrophobic.

When the number of carbon atoms of the alkyl groups denoted by R¹ and R² is less than 5, the hydrophobic rendering effect on the surface of the magnetic particles is inadequate. Conversely, when the number of carbon atoms of these alkyl groups exceeds 10, the water solubility of the compound denoted by general formula (I) decreases. That makes it difficult for the compound denoted by general formula (I) to uniformly adsorb to the surface of the magnetic particles in the water-based solvent. Accordingly, the number of carbon atoms of each alkyl group is equal to or fewer than 10. R¹ and R² may be identical or different. From the perspective of water solubility, a compound such that the sum of the number of carbon atoms of the alkyl group denoted by R¹ and the number of carbon atoms of the alkyl group denoted by R² is equal to or less than 16 is desirable.

In general formula (I), X¹ and X² denote hydrogen atoms or substituents, with either X¹ or X² denoting a functional group that becomes an anionic group in the magnetic liquid. The compound denoted by general formula (I) has a group that becomes an anionic group in the water-based solvent, allowing adsorption to the surface of the magnetic particles that have been positively charged with hydrophobic groups R¹ and R² facing outward. Thus, the surface of the magnetic particles can be rendered hydrophobic.

Examples of functional groups that become anionic groups in water-based solvents are various functional groups that are capable of negatively ionizing in water-based solvents, such as sulfonic acid (salt) groups, sulfuric acid (salt) groups, carboxylic acid (salt) groups, and phosphoric acid (salt) groups. In this context, the term “sulfonic acid (salt) group” includes the sulfonic acid group (—SO₃H) and sulfonate groups having an alkali metal as a counter ion, such as —SO₃Na, —SO₃Li, and —SO₃K. The same applies to sulfuric acid (salt) groups, carboxylic acid (salt) groups, and phosphoric acid (salt) groups. Since compounds having the above functional group in the form of a sulfonic acid (salt) group are readily available, they are suitably employed in the present invention.

Either X¹ or X² denotes the above functional group, and the other denotes a hydrogen atom or substituent. The details of the substituent are as set forth above. The steric hindrance of the groups present in the vicinity of the anionic group is desirably low to achieve good adsorption of the anionic group on the surface of the magnetic particles. In this regard, whichever among X¹ and X² is not a functional group is desirably a hydrogen atom.

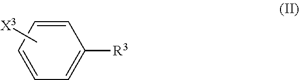

In general formula (II), R³ denotes an alkyl group with 12 to 17 carbon atoms and X³ denotes a functional group that becomes an anionic group in a water-based solvent.

In general formula (II), when the number of carbon atoms of the alkyl group denoted by R³ is less than 12, the hydrophobic rendering effect on the surface of the magnetic particles is inadequate. Conversely, when the number of carbon atoms of the alkyl group exceeds 17, the water solubility of the compound denoted by general formula (II) decreases, making it difficult for the compound denoted by general formula (II) to uniformly adsorb to the surface of the magnetic particles in the water-based solvent. Accordingly, the number of carbon atoms in the alkyl group denoted by R³ is set to the range of 12 to 17. The alkyl group denoted by R³ can be linear or branched. From the perspective of the hydrophobic rendering effect on the surface of the magnetic particles, it is desirably linear. Additionally, since the symmetry of structure decreases when it is a branched alkyl group, a branched alkyl group is advantageous relative to a linear alkyl group with an identical number of carbon atoms, from the perspective of enhancing the solubility in water and organic solvents.

The details of the functional group denoted by X³ in general formula (II) are as set forth above for general formula (I). The substitution position on the functional group denoted by X³ is desirably the para position with respect to R³ from the perspective of the hydrophobic rendering effect on the surface of the magnetic particles.

Both the compound denoted by general formula (I) and the compound denoted by general formula (II) can be synthesized by known methods and are readily available as commercial products. Specific examples of the compound denoted by general formula (I) and the compound denoted by general formula (II) are given below.

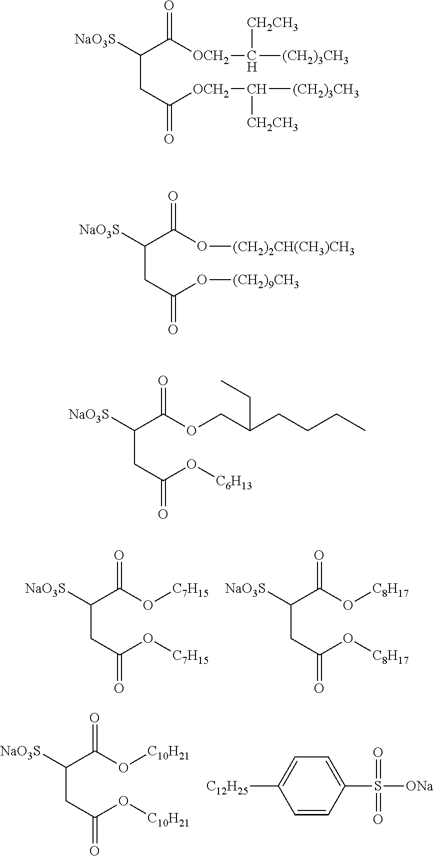

In the present invention as set forth above, the surface of the magnetic particles is modified in a water-based solvent. Adding the surface-modifying agent and conducting surface modification processing after an adequate positive charge has been imparted to the surface of the magnetic particles by the dispersion processing that is conducted prior to the surface modification processing is desirable because it causes the surface-modifying agent to adsorb uniformly and well to the surface of the magnetic particles via the anionic group. Accordingly, it is desirable to add the surface-modifying agent and stir the mixture (surface modification processing) after the magnetic particles have been added to a water-based solvent that has been adjusted to a lower pH than the isoelectric point of the magnetic particles and thorough dispersion processing has been conducted. Both the dispersion processing and surface modification processing can be conducted using a known dispersion apparatus such as a sand mill. The processing time is not specifically limited, and need only be set so that the surface of the magnetic particles is rendered adequately hydrophobic. For example, dispersion processing can be conducted for about 1 to 5 hours prior to adding the surface-modifying agent, followed by stirring for about another 5 minutes to one hour after adding the surface-modifying agent.

A single surface-modifying agent or a combination of two or more can be employed in surface modification processing. Both the surface-modifying agent denoted by general formula (I) and that of general formula (II) exhibit good surface-modifying effects. The surface-modifying agent denoted by general formula (I) is desirable to achieve a better surface-modifying effect. The surface-modifying agent employed need only be employed in a quantity adequate to adjust the zeta potential of the magnetic particles to 0 to 25 mV. From the perspective of forming a uniform hydrophobic surface on the magnetic particles, equal to or more than five weight parts per 100 weight parts of magnetic particles are desirable. When the quantity employed is excessive, there are cases in which the surface-modifying agent adsorbs in two layers on the surface of the magnetic particles, resulting in inadequate hydrophobic rendering. To achieve adequate hydrophobic rendering, the use of equal to or less than 15 weight parts of surface-modifying agent per 100 weight parts of magnetic particles is desirable, and the use of equal to or less than 10 weight parts is preferred. The use of the water-based solvent in a quantity of 100 to 500-fold the quantity of the magnetic particles (based on weight) is desirable to achieve good dispersion processing and surface modification processing of the magnetic particles.

### Preparation of the Magnetic Coating Material

The above dispersion processing and surface modification processing are conducted in a water-based solvent. When a magnetic coating material containing the water-based solvent is employed to form a magnetic layer, the magnetic layer that is formed becomes hydrophilic. Thus, there is a concern that problems such as plasticization will occur due to moisture absorption. Accordingly, a magnetic coating material with an organic solvent system is employed to form the magnetic layer in the present invention. In this context, the term “organic solvent” means a non-water-based organic solvent; trace amounts of moisture of a degree that does not cause problems such as plasticization in the magnetic coating material are permitted.

Following surface modification processing, the magnetic particles are subjected to dispersion processing with an organic solvent and binder to prepare a magnetic coating material with an organic solvent system.

In one embodiment, after surface modification processing, magnetic particles are collected from the water-based solvent and used to prepare a magnetic coating material. For example, after using a known method such as filtration to collect the surface-modified magnetic particles from the water-based solvent and drying them, the magnetic particles obtained can be employed to prepare a magnetic coating material by the same method as that used to prepare the magnetic layer coating material of an ordinary magnetic recording medium. In another embodiment, without conducting drying, the water-based solvent is replaced with an organic solvent in solvent replacement processing following surface modification processing, after which the magnetic particles obtained are used to prepare a magnetic coating material by the same method as that used to prepare the magnetic layer coating material of an ordinary magnetic recording medium. Even when the magnetic particles aggregate during drying, the present invention makes it possible to readily disperse the aggregate in an organic medium.

The above solvent replacement can be conducted by a known method. The following method is one example.

The magnetic liquid obtained by the above surface modification processing is passed through a filter. Desirably, the supernatant of the magnetic liquid in which a precipitate has been formed by processing with a surface-modifying agent is removed by decantation to obtain the precipitate, which is passed through a filter. In the above surface modification processing, the surface-modifying agent adsorbs, neutralizing the positive charge of the surface of the magnetic particles. This results in a reduction in the repulsive force due to the positive charges and renders the surface of the magnetic particles hydrophobic. Thus, the magnetic particles enter a state in which they tend to precipitate. Accordingly, the magnetic particles naturally precipitate in the water-based solvent, facilitating solid-liquid separation of the magnetic liquid.

Subsequently, before the material captured by the filter dries, a solvent (such as alcohol) that is miscible in both water and the organic solvent employed in the magnetic coating material is poured onto the filter to remove moisture remaining in the material captured by the filter. Next, pouring an organic solvent onto the filter replaces the water-based solvent with an organic solvent. Using the material captured by the filter that has been obtained in this manner, it is possible to prepare a magnetic coating material by the same method as that used to prepare the magnetic layer coating material of an ordinary magnetic recording medium.

Examples of the organic solvent that is employed in the magnetic coating material are those organic solvents that are generally employed to prepare particulate magnetic recording media. Specific examples thereof are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane; these may be employed in any ratio. Among them, from the perspectives of the solubility of the binders that are commonly employed in magnetic recording media and adsorption of binder onto the surface of the magnetic particles, the use of an organic solvent containing a ketone (ketone-based organic solvent) is desirable.

These organic solvents need not be 100 percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. To improve dispersion properties, a solvent having a somewhat strong polarity is desirable. It is desirable that solvents having a dielectric constant equal to or higher than 15 are comprised equal to or higher than 50 weight percent of the solvent composition. Further, the dissolution parameter is desirably 8 to 11.

The magnetic particles that have been subjected to dispersion processing with the organic solvent has been processed with a surface-modifying agent in a water-based solvent, rendering the surface thereof hydrophobic. Accordingly, during the usual dispersion processing conducted to form a magnetic layer, a high degree of dispersion can be achieved.

Specific embodiments of the method of manufacturing a magnetic recording medium of the present invention will be described below.

### Magnetic Layer

The magnetic layer in the present invention is a layer that contains magnetic particles that have been processed as set forth above and binder. The magnetic particles employed, as set forth above, can be any of the various ferromagnetic particles commonly employed in the magnetic layer of a magnetic recording medium, such as hexagonal ferrite magnetic particles and ferromagnetic metal magnetic particles. Further, the average primary particle size of the magnetic particles employed in the present invention is as set forth above.

Hexagonal ferrite magnetic particles and ferromagnetic metal magnetic particles will be described in greater detail below.

(i) Hexagonal Magnetic Particle

Examples of hexagonal ferrite magnetic particles are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite magnetic particle in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

The average plate ratio [arithmetic average of (plate diameter/plate thickness)] of the hexagonal ferrite magnetic particle desirably ranges from 1 to 15, preferably 1 to 7. When the average plate diameter ranges from 1 to 15, adequate orientation can be achieved while maintaining high filling property in the magnetic layer, as well as increased noise due to stacking between particles can be suppressed. The specific surface area by BET method (S_{BET}) within the above particle size range is desirably equal to or higher than 40 m²/g, preferably 40 to 200 m²/g, and more preferably, 60 to 100 m²/g.

Narrow distributions of particle plate diameter and plate thickness of the hexagonal ferrite powder are normally good. 500 particles can be randomly measured in a transmission electron microscope (TEM) photograph of particles to measure the particle plate diameter and plate thickness. The distributions of particle plate diameter and plate thickness are often not a normal distribution. However, when expressed as the standard deviation to the average size, a/average size is normally 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

Methods of manufacturing the hexagonal ferrite magnetic particle include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. The hexagonal ferrite magnetic particle employed in the present invention can be manufactured by any of the manufacturing methods. As needed, the hexagonal ferrite magnetic particle can be surface treated with Al, Si, P, or an oxide thereof. The quantity is set to, for example, 0.1 to 10 weight percent of the ferromagnetic particle. When applying a surface treatment, the quantity of a lubricant such as a fatty acid that is adsorbed is desirably not greater than 100 mg/m². Reference can be made to the above-described Japanese Examined Patent Publication (KOKOKU) Showa No. 62-50889 with regard to the above surface treatment. The hexagonal ferrite magnetic particle will sometimes contain inorganic ions such as soluble Na, Ca, Fe, Ni, or Sr. These are desirably substantially not present, but seldom affect characteristics at equal to or less than 200 ppm.

(ii) Ferromagnetic Metal Magnetic Particle

The ferromagnetic metal magnetic particle is not specifically limited, but preferably a ferromagnetic metal magnetic particle comprised primarily of α-Fe. In addition to prescribed atoms, the following atoms can be contained in the ferromagnetic metal magnetic particle: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content desirably ranges from 0 to 40 atom percent, preferably from 15 to 35 atom percent, more preferably from 20 to 35 atom percent with respect to Fe. The content of Y desirably ranges from 1.5 to 12 atom percent, preferably from 3 to 10 atom percent, more preferably from 4 to 9 atom percent with respect to Fe. The Al content desirably ranges from 1.5 to 12 atom percent, preferably from 3 to 10 atom percent, more preferably from 4 to 9 atom percent with respect to Fe.

The ferromagnetic metal magnetic particle may contain a small quantity of hydroxide or oxide. Ferromagnetic metal magnetic particles obtained by known manufacturing methods may be employed. The following are examples of methods of manufacturing ferromagnetic metal magnetic particles: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal magnetic particle is desirably 45 to 100 m²/g, preferably 50 to 80 m²/g. At 45 m²/g and above, low noise can be achieved. At 100 m²/g and below, good surface properties can be achieved in the magnetic layer. The crystallite size of the ferromagnetic metal magnetic particle is desirably 40 to 180 Angstroms, preferably 40 to 150 Angstroms, and more preferably, 40 to 110 Angstroms. The acicular ratio of the ferromagnetic metal magnetic particle is desirably equal to or greater than 3 and equal to or less than 15, preferably equal to or greater than 3 and equal to or less than 12.

The moisture content and pH of the ferromagnetic metal magnetic particle is desirably optimized depending on the type of binder combined. The moisture content of the ferromagnetic metal magnetic particle is desirably 0.01 to 2 percent. A range of pH 4 to 12 can be established, with 6 to 10 being preferred. As needed, the ferromagnetic metal magnetic particle can be surface treated with Al, Si, P, or an oxide thereof. The quantity can be set to 0.1 to 10 weight percent of the ferromagnetic metal magnetic particle. When applying a surface treatment, the quantity of a lubricant such as a fatty acid that is adsorbed is desirably not greater than 100 mg/m². Reference can be made to the above-described Japanese Examined Patent Publication (KOKOKU) Showa No. 62-50889 with regard to the above surface treatment. The ferromagnetic metal magnetic particle will sometimes contain inorganic ions such as soluble Na, Ca, Fe, Ni, or Sr. These are desirably substantially not present, but seldom affect characteristics at 200 ppm or less. The ferromagnetic metal magnetic particle employed in the present invention desirably has few voids; the level is desirably 20 volume percent or less, preferably 5 volume percent or less. So long as the particle size characteristics as set forth above are satisfied, the ferromagnetic metal magnetic particle may be acicular, rice grain-shaped, or spindle-shaped.

(iii) Binder

Examples of the binder for use in the magnetic coating material employed for the formation of magnetic layer are: polyurethane resins; polyester resins; polyamide resins; vinyl chloride resins; styrene; acrylonitrile; methyl methacrylate and other copolymerized acrylic resins; nitrocellulose and other cellulose resins; epoxy resins; phenoxy resins; and polyvinyl acetal, polyvinyl butyral, and other polyvinyl alkyral resins. These may be employed singly or in combinations of two or more. Of these, the desirable binders are the polyurethane resins, acrylic resins, cellulose resins, and vinyl chloride resins. These resins may also be employed as binders in the nonmagnetic layer described further below. Reference can be made to paragraphs [0029] to [0031] in Japanese Unexamined Patent Publication (KOKAI) No. 2010-24113, which is expressly incorporated herein by reference in its entirety, for details of the binder. A polyisocyanate curing agent may also be employed with the above resins.

(vi) Additives

As needed, additives can be added to the magnetic layer. Examples of additives are: abrasives, lubricants, dispersing agents, dispersion adjuvants, antifungal agents, antistatic agents, oxidation inhibitors, and carbon black. These additives may be employed in the form of a commercial product suitably selected based on desired properties.

Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml. When employing carbon black, the quantity desirably ranges from 0.1 to 30 weight percent with respect to the weight of the ferromagnetic powder. For example, the Carbon Black Handbook compiled by the Carbon Black Association, which is expressly incorporated herein by reference in its entirety, may be consulted for types of carbon black suitable for use in the magnetic layer. Commercially available carbon black can be employed.

### Nonmagnetic Layer

Details of the nonmagnetic layer will be described below. In the present invention, a nonmagnetic layer comprising a nonmagnetic powder and a binder can be formed between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides. These nonmagnetic powders are commercially available and can be manufactured by the known methods. Reference can be made to paragraphs [0036] to [0039] in Japanese Unexamined Patent Publication (KOKAI) No. 2010-24113 for details thereof.

Binders, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersing agents employed in the magnetic layer may be adopted thereto. Carbon black and organic powders can be added to the nonmagnetic layer. Reference can be made to paragraphs [0040] to [0042] in Japanese Unexamined Patent Publication (KOKAI) No. 2010-24113 for details thereof.

### Nonmagnetic Support

The magnetic coating material that has been prepared by the above method is coated directly, or through another layer such as a nonmagnetic layer, on the nonmagnetic support. As a result, a magnetic recording medium having the magnetic layer on the nonmagnetic support, as needed, through another layer such as a nonmagnetic layer can be obtained.

A known film such as biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The center average roughness, Ra, at a cutoff value of 0.25 mm of the nonmagnetic support suitable for use in the present invention desirably ranges from 3 to 10 nm.

### Layer Structure

As for the thickness structure of the magnetic recording medium obtained by the present invention, the thickness of the nonmagnetic support desirably ranges from 3 to 80 μm. The thickness of the magnetic layer can be optimized based on the saturation magnetization of the magnetic head employed, the length of the head gap, and the recording signal band, and is normally 10 to 150 nm, desirably 20 to 120 nm, and preferably, 30 to 100 nm. At least one magnetic layer is sufficient. The magnetic layer may be divided into two or more layers having different magnetic characteristics, and a known configuration relating to multilayered magnetic layer may be applied.

The nonmagnetic layer is, for example, 0.1 to 3.0 μm, desirably 0.3 to 2.0 μm, and preferably, 0.5 to 1.5 μm in thickness. The nonmagnetic layer of the magnetic recording medium of the present invention can exhibit its effect so long as it is substantially nonmagnetic. It can exhibit the effect of the present invention, and can be deemed to have essentially the same structure as the magnetic recording medium of the present invention, for example, even when impurities are contained or a small quantity of magnetic material is intentionally incorporated. The term “essentially the same” means that the residual magnetic flux density of the nonmagnetic layer is equal to or lower than 10 mT, or the coercive force is equal to or lower than 7.96 kA/m (equal to or lower than 100 Oe), with desirably no residual magnetic flux density or coercive force being present.

### Backcoat Layer

A backcoat layer can be provided on the surface of the nonmagnetic support opposite to the surface on which the magnetic layer are provided, in the present invention. The backcoat layer desirably comprises carbon black and inorganic powder. The formula of the magnetic layer or nonmagnetic layer can be applied to the binder and various additives for the formation of the backcoat layer. The backcoat layer is preferably equal to or less than 0.9 μm, more preferably 0.1 to 0.7 μm, in thickness.

### Manufacturing Process

With the exception that magnetic particles obtained by dispersion processing with a surface-modifying agent in a water-based solvent are employed, the coating liquid (magnetic coating material) for forming the magnetic layer is prepared by the same method as that used to prepare an ordinary magnetic layer coating liquid.

The process for manufacturing magnetic layer, nonmagnetic layer and backcoat layer coating liquids normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the magnetic particle, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic layer, nonmagnetic layer and backcoat layer coating liquids. Dispersing media with a high specific gravity such as zirconia beads, titania beads, and steel beads are also suitable for use. The particle diameter and filling rate of these dispersing media can be optimized for use. A known dispersing device may be employed. Reference can be made to paragraphs [0051] to [0057] in Japanese Unexamined Patent Publication (KOKAI) No. 2010-24113 for details of the method of manufacturing a magnetic recording medium.

The present invention permits the formation of a magnetic layer in which microparticulate magnetic material is highly dispersed. Thus, the present invention can provide a magnetic recording medium for high-density recording that achieves good electromagnetic characteristics. That is, the magnetic recording medium obtained by the manufacturing method of the present invention is suitable as a magnetic recording medium for high-density recording. For example, the magnetic recording medium of the present invention can be used to record a magnetic signal at linear recording densities of 400 Kbpi and above and reproduce the magnetic signal. In particular, the magnetic recording medium of the present invention exhibits a high SNR in systems exceeding a linear recording density of 500 Kbpi, and the improvement in the SNR is marked in systems with linear recording densities of 550 Kbpi and above. The linear recording density is preferably 550 to 600 Kbpi.

A magnetoresistive (MR) head is desirably employed to reproduce with high sensitivity magnetic signals that have been recorded at high densities. Since MR heads are highly sensitive, noise also tends to be detected with high sensitivity. The magnetic recording medium of the present invention makes it possible to reduce the noise caused by aggregation of microparticulate magnetic material, so a high SNR can be achieved in reproduction with MR heads. From the perspective of high sensitivity reproduction, it is desirable to employ an MR head with a shield spacing of 0.05 to 0.2 μm.

### EXAMPLES

The present invention will be described in detail below based on examples. However, the present invention is not limited to the examples. The terms “parts” and “percent” given in Examples are weight parts and weight percent unless specifically stated otherwise.

### Examples 1 to 7, Comparative Examples 2 to 8

1. Preparation of Base Liquids 1 to 5

After adding 300 parts of water to 100 parts of barium ferrite magnetic particles, base liquids 1 to 4 were adjusted to the pH levels indicated in Table 1 with a 30 percent acetic acid aqueous solution and base liquid 5 with a 30 percent ammonia aqueous solution. Subsequently, at room temperature (about 25° C.), aqueous solutions containing the magnetic particles were dispersed in a sand mill (dispersion period: see Table 1) to prepare base liquids 1 to 5.

2. Measurement of Isoelectric Point and Average Primary Particle Size of Starting Material Magnetic Particles

The barium ferrite magnetic particles employed in base liquids 1 to 5 were collected from a single lot. Thus, they had an identical average primary particle size and isoelectric point. Accordingly, samples of particles for use in measuring the isoelectric point and average primary particle size were collected from the lot. The sample particles for use in isoelectric point measurement were added to water to a barium ferrite magnetic particle density of 0.02 percent, and a pH adjusting agent (30 weight percent acetic acid aqueous solution) was added while monitoring the zeta potential with a zeta potential measuring apparatus (Zetasizer Nano Series made by Sysmex). The pH was measured when the zeta potential went to zero. That pH value was adopted as the isoelectric point of the barium ferrite magnetic particles. The isoelectric points measured ranged from 8 to 9.

The sample particles for use in measuring the average primary particle size were photographed at a magnification of 100,000-fold with a model H-9000 transmission electron microscope made by Hitachi and printed on photographic paper at an overall magnification of 500,000 to obtain particle photographs. The targeted magnetic particles were selected in the particle photograph, the contours of the particles were traced with a digitizer, and the size of the particles was measured with image analysis software KS-400 from Carl Zeiss. The size (maximum major diameter) of 500 primary particles was measured. The arithmetic average of the maximum major diameter measured by this method was adopted as the primary particle size of the barium ferrite magnetic particles. The average primary particle size measured was 25 nm.

3. Measurement of the Particle Diameter in Liquid

A portion of each of the various base liquids was collected, and each of the liquids collected was added to water that had been adjusted to the same pH as the various base liquids to achieve a barium ferrite concentration of 0.2 percent and obtain solutions. The particle size distribution in the solutions thus prepared was measured with an LB-500 dynamic light-scattering particle size distribution measuring device made by Horiba, Ltd. (measurement was repeated 50 times).The maximum major diameter corresponding to 50 percent of the cumulative distribution curve of the particle size distribution measured was adopted as the particle diameter in liquid of the base liquid.

The above results are given in Table 1.

TABLE 1

| | | | | Particle |
|---|---|---|---|---|
| | | Isoelectric point of | Dispersion | diameter in |
| | | starting material | period | liquid |
| | pH | magnetic particles | (h) | (nm) |
| Base liquid 1 | 3.0 | 8-9 | 4 | 25 |
| Base liquid 2 | 4.0 | 8-9 | 4 | 30 |
| Base liquid 3 | 5.0 | 8-9 | 4 | 35 |
| Base liquid 4 | 6.0 | 8-9 | 4 | 50 |
| Base liquid 5 | 12.0 | 8-9 | 8 | 35 |

4. Processing with a Surface-Modifying Agent

To 100 parts of the barium ferrite magnetic particles in the base liquids shown in Table 1 were added the surface-modifying agents shown in Table 2 in the quantities shown in Table 2, after which stirring (surface modification processing) was conducted for 30 minutes in a sand mill.

A portion of the magnetic liquid (slurry) was collected following surface modification processing. The liquid collected was diluted with water that had been adjusted to the same pH as each of the base liquids to a barium ferrite concentration of 0.02 percent to prepare a liquid. The zeta potential of the diluted liquid thus prepared was measured with a Zetasizer Nano Series made by Sysmex (measurement was repeated 100 times). The zeta potentials that were measured are given in Table 2.

Separately, a portion of the magnetic liquid (slurry) was collected after surface modification processing and added to water adjusted to the same pH as the water employed in the preparation of the various base liquids to a barium ferrite concentration of 0.2 percent to prepare solutions. The particle size distribution of the barium ferrite magnetic particles in the solutions thus prepared was measured with an LB-500 dynamic light-scattering particle size distribution measuring device made by Horiba, Ltd. (measurement was repeated 50 times).The maximum major diameter corresponding to 50 percent of the cumulative distribution curve of the particle size distribution measured was adopted as the particle diameter in liquid following surface modification processing.

5. Collection of Magnetic Particles

The magnetic liquid after surface modification processing of 4. above was filtered using a Nutsche filter and suction bottle. The barium ferrite magnetic particles that remained on the filter paper were dried for 10 hours in a 120° C. oven.

6. Components of the Magnetic Coating Material
Barium ferrite magnetic particles obtain in 5. above: 100 parts
Vinyl chloride polymer (MR110 made by Zeon Corporation): 5 parts
Polyurethane resin (UR8200 made by Toyobo): 3 parts
Isocyanate-based curing agent (Coronate L, made by Nippon Polyurethane Industry Co., Ltd.): 5 parts
Carbon black #50 (made by Asahi Carbon): 1 part
Butyl stearate: 1 part
Butoxyethyl stearate: 1 part
Isohexadecyl stearate: 1 part
Stearic acid: 2 parts
Methyl ethyl ketone: 125 parts
Cyclohexanone: 125 parts

7. Preparation of Magnetic Coating Material

The various components of 6. above were kneaded in a kneader, dispersion processed for the period indicated in Table 2 in a sand mill, and filtered using a filter having an average pore diameter of 1 μm to prepare a magnetic coating material.

8. Components of the Nonmagnetic Layer Coating Liquid
Nonmagnetic powder TiO₂ crystal-based rutile: 80 parts

Average primary particle diameter: 0.035 μm

Specific surface area by BET method: 40 m²/g

pH: 7

TiO₂ content: equal to or greater than 90 weight percent

DBP oil absorption capacity: 27 to 38 g/100 g

Surface treatment agent: Al₂O₃ (8 weight percent)
Carbon black (Conductex SC-U made by Columbia Carbon): 20 parts
Vinyl chloride resin (MR110 made by Zeon Corporation): 12 parts
Polyurethane resin (Vylon UR82000 made by Toyobo): 5 parts
Butyl stearate: 1 part
Butoxyethyl stearate: 1 part
Isohexadecyl stearate: 3 parts
Stearic acid: 3 parts
Methyl ethyl ketone/cyclohexanone (8/2 mixed solvent): 250 parts

9. Preparation of Nonmagnetic Layer Coating Liquid

The various components of 8. above were kneaded in a kneader, dispersed in a sand mill, and filtered using a filter having an average pore diameter of 1 μm to prepare a nonmagnetic coating liquid.

10. Preparation of Magnetic Tape

The nonmagnetic layer coating liquid prepared in 9. above was coated in a quantity calculated to yield a thickness upon drying of 1.0 μm on a polyethylene terephthalate support with a thickness of 6 μm and a center plane average surface roughness of 3 nm and dried. Subsequently, the magnetic coating material (magnetic layer coating liquid) prepared in 7. above was coated at a coating rate of 100 m/minute. Immediately following coating, a 318 kA/m (4,000 Oe) magnetic field was applied perpendicular to the web to impart a perpendicular orientation. After drying, processing was conducted with a seven-stage calender at 90° C. and at a linear pressure of 300 kg/cm (2940 N/cm). The magnetic tape obtained had a magnetic layer thickness of 85 nm.

### Comparative Example 1

Barium ferrite magnetic particles (average primary particle size: 25 nm) collected from the same lot as the barium ferrite magnetic particles employed to prepare base liquids 1 to 5 were used to prepare a magnetic tape by the same method as in above Examples with the exception that they were employed in unprocessed form to prepare the magnetic coating material.

11. Particle Diameter in Liquid of Magnetic Particles in Magnetic Coating Material

A portion of the magnetic coating materials prepared in each of the Examples and comparative examples was collected. The collected liquids were diluted with 1:1 (weight ratio) of a mixed solvent of methyl ethyl ketone and cyclohexanone to a barium ferrite concentration of 0.2 percent to prepare liquids. The particle size distribution of the barium ferrite magnetic particles in the diluted liquids thus prepared was measured with an LB-500 dynamic light-scattering particle size distribution measuring device made by Horiba, Ltd. (measurement was repeated 50 times).The maximum major diameter corresponding to 50 percent of the cumulative distribution curve of the particle size distribution measured was adopted as the particle diameter in liquid of the magnetic coating material. The smaller the difference between the average primary particle size of the starting material barium ferrite magnetic particles and the particle diameter in liquid of the magnetic coating material, the greater the dispersion of the magnetic particles in the magnetic coating material exhibited.

12. Evaluation of Electromagnetic Characteristics (SNR)

The SNR of each of the various magnetic tapes of the Examples and comparative examples was measured by the following method with a ½ inch linear system having a fixed head. The relative velocity of the head/tape was 10 m/s.

An MIG head (gap length: 0.2 μm, track width 8 μm) with a saturation magnetic flux density of 1.8 T was employed as the recording head. The recording current was set to the optimal recording current for each tape and a magnetic signal was recorded in the longitudinal direction of the tape at a linear recording density of 600 Kbpi. The recorded magnetic signal was reproduced using an anisotropic MR (A-MR) head with an element thickness of 15 nm and a shield spacing of 0.05 μm as the reproduction head. The reproduced signal was frequency analyzed with a spectrum analyzer made by Shibasoku, and the ratio of the carrier signal output to the integral noise of the full spectral bandwidth was adopted as the SNR.

The above results are shown in Table 2.

TABLE 2

| | | | | | Particle | | | Particle | |
|---|---|---|---|---|---|---|---|---|---|
| | | Particle | Surface-modifying agent or | | diameter in | Zeta | Dispersion | diameter in | |
| | | diameter in | water-soluble polymer | | liquid after | potential in | period of the | liquid of the | |
| | | liquid of the | | Quantity | surface | water | magnetic | magnetic | |
| | Base | base liquid | | added | modification | dispersion | coating | coating | SNR |
| | liquid | (nm) | Type | (parts) | processing (nm) | liquid (mV) | material (h) | material (nm) | (dB) |
| Ex. 1 | 1 | 25 | Sodium | 5 | 5500 | 9 | 0.5 | 30 | 1.5 |
| | | | di(2-ethylhexyl) | | | | | | |
| | | | sulfosuccinate | | | | | | |
| Ex. 2 | 1 | 25 | Sodium | 10 | 6000 | 5 | 0.5 | 25 | 2.0 |
| | | | di(2-ethylhexyl) | | | | | | |
| | | | sulfosuccinate | | | | | | |
| Ex. 3 | 1 | 25 | Sodium | 15 | 6000 | 0 | 0.5 | 30 | 1.5 |
| | | | di(2-ethylhexyl) | | | | | | |
| | | | sulfosuccinate | | | | | | |
| Ex. 4 | 2 | 30 | Sodium | 10 | 5500 | 9 | 0.5 | 30 | 1.5 |
| | | | di(2-ethylhexyl) | | | | | | |
| | | | sulfosuccinate | | | | | | |
| Ex. 5 | 3 | 35 | Sodium | 10 | 4300 | 15 | 0.5 | 35 | 0.5 |
| | | | di(2-ethylhexyl) | | | | | | |
| | | | sulfosuccinate | | | | | | |
| Ex. 6 | 1 | 25 | Decyl isopentyl | 5 | 5600 | 8 | 0.5 | 25 | 2.0 |
| | | | sulfosuccinate | | | | | | |
| | | | sodium | | | | | | |
| Ex. 7 | 1 | 25 | Sodium | 5 | 5800 | 18 | 0.5 | 35 | 0.5 |
| | | | dodecylbenzene | | | | | | |
| | | | sulfonate | | | | | | |
| Ex. 8 | 1 | 25 | 2-(Sodiosulfo) | 5 | 5500 | 9 | 0.5 | 30 | 1.5 |
| | | | succinic acid | | | | | | |
| | | | didecyl ester | | | | | | |
| Comp. Ex. 1 | — | — | — | — | — | — | 12 | 35 | 0.0 |
| Comp. Ex. 2 | 1 | 25 | Sodium | 2 | 140 | 30 | 12 | 35 | −1.0 |
| | | | di(2-ethylhexyl) | | | | | | |
| | | | sulfosuccinate | | | | | | |
| Comp. Ex. 3 | 1 | 25 | Sodium | 18 | 160 | −5 | 12 | 75 | −2.0 |
| | | | di(2-ethylhexyl) | | | | | | |
| | | | sulfosuccinate | | | | | | |
| Comp. Ex. 4 | 4 | 50 | Sodium | 10 | 300 | 15 | 12 | 52 | −1.5 |
| | | | di(2-ethylhexyl) | | | | | | |
| | | | sulfosuccinate | | | | | | |
| Comp. Ex. 5 | 1 | 25 | Water-soluble | 5 | 5300 | −10 | 15 | 90 | −5.2 |
| | | | polymer (sodium | | | | | | |
| | | | polyacrylate, | | | | | | |
| | | | average | | | | | | |
| | | | molecular | | | | | | |
| | | | weight: 2000) | | | | | | |
| Comp. Ex. 6 | 1 | 25 | Sodium | 5 | 3200 | 30 | 12 | 50 | −1.3 |
| | | | di(dodecyl) | | | | | | |
| | | | sulfosuccinate | | | | | | |
| Comp. Ex. 7 | 1 | 25 | Sodium octane | 5 | 5400 | 9 | 12 | 80 | −4.5 |
| | | | sulfonate | | | | | | |
| Comp. Ex. 8 | 5 | 55 | Sodium | 5 | 70 | −20 | 12 | 60 | −1.7 |
| | | | di(2-ethylhexyl) | | | | | | |
| | | | sulfosuccinate | | | | | | |

The structures of the surface-modifying agents employed in the Examples and comparative examples is shown below.

### Sodium di(2-ethylhexyl)sulfosuccinate

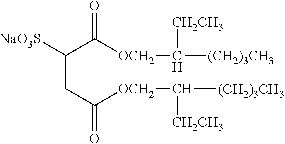

### Decyl isopentyl sulfosuccinate sodium

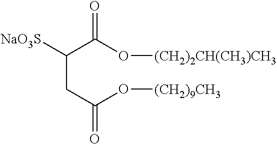

### Sodium dodecylbenzene sulfonate

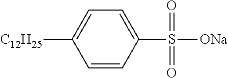

### 2-(Sodiosulfo)succinic acid didecyl ester

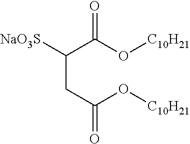

### Sodium di(dodecyl)sulfosuccinate

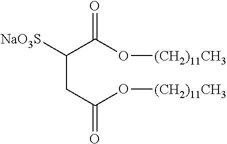

### Sodium octane sulfonate

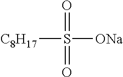

Evaluation Results

The particle diameters in liquid of the magnetic coating materials shown in Table 2 are indicators of aggregation of the magnetic particles in the magnetic coating materials. The closer the particle diameter in liquid is to the average primary particle size (25 nm) of the starting material magnetic particles, the higher the degree of dispersion of the magnetic particles in the magnetic coating material. Using such a magnetic coating material to form a magnetic layer makes it possible to obtain a magnetic recording medium exhibiting good electromagnetic characteristics (SNR).

However, those of the magnetic coating materials shown in Table 2 that exhibit low SNRs despite a particle diameter in liquid that is close to the average primary particle size of the starting material magnetic particles do so because of a decrease in the particle diameter in liquid due to the presence in the magnetic coating material of minute pulverized matter in the form of magnetic particles pulverized in the dispersion process, precluding the formation of a magnetic layer with highly dispersed magnetic particles. It was thought that the noise increased due to the presence of the minute pulverized matter in the magnetic layer, causing the SNR to drop.

As shown in Table 2, in Examples 1 to 8, the particle diameter in liquid of the magnetic coating materials was close to the average primary particle size of the starting material barium ferrite magnetic particles, and the SNR was good. As a result, in Examples 1 to 8, it can be determined that a magnetic layer was formed in which the magnetic particles were dispersed to a high degree in a state close to that of primary particles. In Examples 1 to 8, the particle diameter in liquid after surface modification processing was much greater than the average primary particle size of the starting material barium ferrite magnetic particles. This was because they were coated with the surface-modifying agent, neutralizing the positive charge of the magnetic particle surface and reducing the repulsive forces between positive charges. As a result, since the particle diameter in liquid of the magnetic coating material was about the same as the average primary particle size of the starting material barium ferrite magnetic particles, it could be confirmed that aggregates resulting from a decrease in the repulsive forces between positive charges were readily dispersed in the magnetic coating material in an organic solvent system.

By contrast, Comparative Example 1 is a comparative example in which starting material magnetic particles were not processed in water and were employed as is to produce a magnetic coating liquid. A long period of dispersion (12 hours) was required to cause the particle diameter in liquid of the magnetic coating material to be close to the average primary particle size of the starting material magnetic particles. The reason the SNR dropped despite a particle diameter in liquid of the magnetic coating material that was about the same as in the Examples is thought to be that the long period of dispersion formed minute pulverized matter which remained in the magnetic layer, increasing noise and compromising the SNR.

In Comparative Example 2, the SNR dropped despite a particle diameter in liquid of the magnetic coating material that was close to the average primary particle size of the starting material barium ferrite magnetic particles. This was attributed to inadequate coating by the surface-modifying agent (a zeta potential of the magnetic particles following processing with the surface-modifying agent exceeding 25 mV), necessitating a long period of dispersion to achieve a particle diameter in liquid of the magnetic coating material of about the same as the average primary particle size of the starting material barium ferrite magnetic particles and resulting in pulverization of the magnetic particles.

Comparative Example 3 is a comparative example in which the zeta potential of the magnetic particles following processing with the surface-modifying agent in water was a negative value. Due to excessive coating by the surface-modifying agent, affinity with the organic solvent decreased, dispersion of the magnetic particles was inadequate despite a dispersion period of the magnetic coating material identical to that in Comparative Example 2 (the particle diameter in liquid in the magnetic coating material was large), and as a result, the SNR dropped.

Comparative Example 4 is a comparative example in which dispersion prior to surface modification processing was inadequate (the particle diameter in the base liquid exceeded 35 nm), making it impossible to achieve a good SNR despite processing with a surface-modifying agent.

Comparative Example 5 is a comparative example in which surface processing was conducted with a water-soluble polymer. A high degree of dispersion could not be achieved in the magnetic coating material (the particle diameter in liquid of the magnetic coating material was large), resulting in a drop in the SNR.

Comparative Example 6 had a particle diameter in liquid of the magnetic coating material that was larger and an SNR that was lower than in the Examples. These were due to inadequate water-solubility of the surface-modifying agent that was employed. Thus, the surface-modifying agent did not uniformly adsorb to the surface of the magnetic particles, precluding a high degree of dispersion of the magnetic particles in the magnetic coating material.

Comparative Example 7 also had a particle diameter in liquid of the magnetic coating material that was larger and an SNR that was lower than in the Examples. These were due to the use of a surface-modifying agent that had an inadequate hydrophobic rendering effect and did not correspond to general formula (I) or (II).

Comparative Example 8 is a comparative example of the use of base liquid 5 prepared using water that exceeded the isoelectric point of the starting material magnetic particles. As shown in Table 1, the particle diameter in liquid of base liquid 5 was close to the average primary particle size of the starting material magnetic particles, but due to the use of water exceeding the isoelectric point, the surface of the magnetic particles developed negative charges, and the repulsive forces of the negative charges increased dispersion of the magnetic particles. However, the anionic groups of the surface-modifying agent did not adhere to the magnetic particles with surfaces in such a negatively charged state. Since a surface-modifying effect could not be achieved by the surface-modifying agent, the magnetic particles could not disperse to a high degree in the magnetic coating material (the particle diameter in liquid of the magnetic coating material increased). As a result, a good SNR was precluded.

The above results indicate that the present invention made it possible to form a magnetic layer in which the magnetic particles were highly dispersed, and as a result, provided a magnetic recording medium with good electromagnetic characteristics.

The present invention is useful in the field of manufacturing magnetic recording media for high-density recording, such as backup tapes.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing a magnetic recording medium comprising:
dispersing magnetic particles in a water-based solvent having a pH that is lower than an isoelectric point of the magnetic particles to prepare a magnetic liquid, wherein the dispersing is conducted to a state of dispersion where a particle diameter in liquid is equal to or lower than 35 nm;
adjusting a zeta potential of the magnetic particles to within a range of 0 to 25 mV by modifying a surface of the magnetic particles with the addition of a surface-modifying agent to the magnetic liquid, the surface-modifying agent being selected from the group consisting of compounds denoted by general formula (I) and compounds denoted by general formula (II); 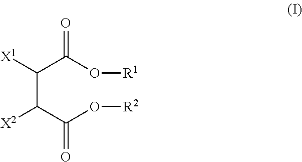
wherein, in general formula (I), each of R¹ and R² independently denotes an alkyl group with 5 to 10 carbon atoms; and X¹ and X² denote hydrogen atoms or substituents, with either X¹ or X² denoting a functional group that becomes an anionic group in the magnetic liquid; 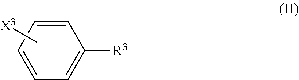
wherein, in general formula (II), R³ denotes an alkyl group with 12 to 17 carbon atoms, and X³ denotes a functional group that becomes an anionic group in the magnetic liquid;
dispersing the magnetic particles after the adjusting together with an organic solvent and a binder to prepare a magnetic coating material; and
forming a magnetic layer of the magnetic recording medium with the magnetic coating material that has been prepared.

2. The method of manufacturing a magnetic recording medium according to claim 1, wherein the functional group that becomes an anionic group in the magnetic liquid is a sulfonic acid group or a sulfonate group.

3. The method of manufacturing a magnetic recording medium according to claim 1, which further comprises, after the surface modification in the magnetic liquid, collecting the magnetic particles from the water-based solvent.

4. The method of manufacturing a magnetic recording medium according to claim 1, wherein the magnetic particles are hexagonal ferrite magnetic particles.

5. The method of manufacturing a magnetic recording medium according to claim 1, which further comprises adjusting the pH of the water-based solvent, the pH being equal to or lower than 5.

6. The method of manufacturing a magnetic recording medium according to claim 1, wherein, in general formula (II), the functional group denoted by X³ is present on a para position with respect to the alkyl group denoted by R³.

7. The method of manufacturing a magnetic recording medium according to claim 1, wherein, in general formula (I), either X¹ or X² denotes the functional group that becomes an anionic group in the magnetic liquid, and the other denotes a hydrogen atom.

8. The method of manufacturing a magnetic recording medium according to claim 1, wherein a content of the surface-modifying agent in the magnetic liquid ranges from 5 to 15 weight parts per 100 weight parts of the magnetic particles.

9. The method of manufacturing a magnetic recording medium according to claim 1, wherein the organic solvent comprises a ketone solvent.

10. The method of manufacturing a magnetic recording medium according to claim 1, wherein, in the adjusting, the zeta potential of the magnetic particles is adjusted to within a range of 0 to 10 mV.

11. A magnetic recording medium manufactured by the manufacturing method according to claim 1.
